(19) United States
(12) Patent Application Publication
(10) Pub. No.: US 2008/0312889 A1
(43) Pub. Date: Dec. 18, 2008

(54) System and Method For Testing a Control Unit System

(76) Inventors: Hermann Maier, Markgroeningen (DE); Peter Schubert-Heidt, Wurmberg (DE)

Correspondence Address: KENYON & KENYON LLP, ONE BROADWAY, NEW YORK, NY, 10004, US

(21) Appl. No.: 11/885,891

(22) PCT Filed: Mar. 8, 2006
(86) PCT No.: PCT/EP2006/060553

§ 371 Date: May 13, 2008

(30) Foreign Application Priority Data
Mar. 11, 2005 (DE) 10 2005 011 246.3

(51) Int. Cl. G06F 11/26

(52) U.S. Cl. 703/3

(57) ABSTRACT

In a system for testing a control unit system having at least one control unit and at least one sensor, the control unit and sensor and possible other bus users being connected to one another via a data bus, and a test signal being fed into one of the bus users for testing the control unit system, at least one of the bus users, in particular a sensor, is replaced by a corresponding emulator of this bus user.

### FIELD OF THE INVENTION

The present invention relates to a system and a method for testing a control unit system having at least one control unit and at least one sensor, the control unit and sensor and any other bus users being connected via a data bus, and a test signal being fed into one of the bus users for testing the control unit system.

### BACKGROUND INFORMATION

Such systems may be used in particular for testing vehicle systems. Vehicle systems, such as ESP (Electronic Stability Program) for skid control, TCS (Traction Control System) for traction regulation, ABS (antilock system) for brake regulation, make use of such control unit systems and are increasingly used in today's motor vehicles. The actuators associated with the vehicle system are activated via a control unit with the aid of appropriate sensors and complex signal processing.

German Patent Application No. DE 197 11 734 describes a system for feeding simulation data into control units and for processing the simulation data. This patent application describes, using the example of an airbag control unit, the use of a single computer for feeding analog simulation signals (crash signals) and for communication with the control unit and for controlling the control unit. A separate computer previously used for feeding the simulation signals and the associated conversion, and scaling of the crash simulation data specially performed for this purpose may thus be omitted (due to the compatibility, which already exists, of the one computer). The analog simulation signal is fed where in the actual case the signal of the acceleration sensor is fed. The signals generated by the control unit due to the simulation, which in normal operation activate appropriate actuators, are detected and analyzed by the same computer.

A method for testing an interface module is also described in German Patent Application No. DE 101 11 266 C1. The test is initiated here by a processor transmitting a first data message to the above-mentioned interface module. This sets the interface module into a test mode so that it no longer transmits sensor data which it receives from a sensor in normal operation, but rather transmits from registers permanently stored test values to this processor. These test sensor values are processed appropriately whereupon the processor activates an additional unit such as an ignition circuit control. The ignition circuit control in turn will activate actuators, namely a restraining device, without deployment occurring in the test mode. A complete test of the sensor value processing in the control unit may be carried out via the test sensor values, described herein, from the registers of the interface module.

German Patent Application Nos. DE 100 49 526 C2 and DE 100 56 549 C2 describe the multiple use of sensor signals by a plurality of vehicle systems. For the above-mentioned vehicle systems, external influences are detected by sensors on and in the vehicle and used to characterize the instantaneous driving situation. Each controller of a vehicle system receives predefined setpoint values, for example, from the driver, and in turn generates activation signals for actuators. The above-mentioned applications describe an estimating module, which detects external manipulated variables via existing sensors and forms actual values as controlled variables which are supplied to all relevant regulators of the vehicle systems. Multiple calculations of vehicle-relevant quantities in the individual vehicle systems may thus be omitted.

It has been found that analog signal feed for testing a control unit system, such as described in German Patent Application No. DE 197 11 734 C2, has reached the limits of its applicability. Feeding signals into sensors that are becoming more and more complex and intelligent is becoming riskier despite the technological progress that is being made, in part because of the progress itself, since more and more protection mechanisms and control circuits are making the sensors less sensitive to interference and external influences. In addition, digital signal processing is pre-shifted to the physical signal recorder such as, for example, the integrated sigma/delta transformer, which excites, at the same time, the signal recorder (capacitive seismic comb). The costs to be borne for testing and stimulus inputs in each sensor in the field are also not negligible. Such additional inputs may, however, also have a negative influence on the behavior of the sensor.

For the above reasons, processing of input quantities via analog stimulation is becoming technically more and more difficult to implement, and generally cannot be performed in a cost- and resource-neutral manner. The signal/noise ratio, intrinsic noise, interference, and inaccuracies represent obstacles in the technical implementation, while reproduction of the desired behavior deteriorates.

In addition, the requirements for tests of vehicle systems, for example, are becoming more stringent, because high safety standards, customer wishes, and more and more complex systems are to be taken into account. Therefore, there is a need for a system and a method for testing a control unit system having at least one control unit and at least one sensor, in particular for vehicle systems, which make it possible to test in a manner that is justifiably simple from the technical viewpoint and with high reliability.

### SUMMARY

In accordance with the present invention, by replacing an original bus user with an appropriate emulator of this bus user in the case of a test, more reliable and more accurate testing is achieved than via the previously known simulation of this bus user. While in the case of a simulation, in general, experiments are performed on a model of reality in order to obtain information about the actual situation, in an emulation the system itself is functionally emulated. In a simulation, the result is the primary objective, while other aspects, which (presumably) play a subordinate role for the question posed, are simplified or totally omitted. In contrast, in emulation, the emulator receives the same data, executes the same programs, and achieves the same results as the emulated system. The emulator, i.e., the system, which emulates another system, may be advantageously operated using the original code from the factory; it may receive the same stimuli as the emulated system and, depending on the design, may contain additional options. The emulator realistically represents the most important functions of the original bus user. Thus, emulation is not only more reliable and more accurate than simulation, but the emulator according to the present invention has a higher performance level, is more stable, and more flexible than the original bus user.

It may be advantageous if the bus user into which the test signal is fed is replaced by its respective emulator. In this case it is advantageous in particular to use an emulator of a sensor for testing a control unit system. The present invention is explained below in the context of a sensor emulator, this sensor emulator being representative, without limitation of generality, of a module/component of a control unit system, i.e., in general of a bus user of such a control unit system communicating via a data bus.

Considering such a sensor as described above, the following units are relevant:

1. the physical bus coupling/bus type,
2. the protocol generation,
3. the processing of the output quantities,
4. the logic/control, and
5. the processing of the input quantities.

The emulation of the logic/controller, processing of output quantities, and protocol generation may be transferred from the original bus user, this transfer being based on porting, for example, the VHDL modules onto the emulator hardware. Such VHDL modules (=VHSIC Hardware Description Language, where VHSIC=Very High Speed Integrated Circuit) are often used today for describing complicated digital systems, this hardware description language describing the desired behavior of a circuit on a higher abstraction level without using individual electronic components. Again, without restriction of generality, in the following we shall primarily speak of VHDL code or VHDL modules for explaining the sensor emulators, the present invention not being limited to this type of hardware description.

Porting the VHDL modules as described above ensures that processing in the emulator is equivalent to that in the original with respect to response, timing, and run time.

Most of the processing of the input quantities may also be transferred, in particular in the case of filtering or a signal-processing component.

Therefore, only one processing level responsible for coupling the bus user (sensor) to be emulated to the control unit system needs to be replaced by an individually useable processing level in the emulator.

The above statement shows that the example emulator according to the present invention assumes the characteristics of the original bus user and has more capabilities than the original bus user due to its individually useable processing level and additional individually useable components. In particular, the number of degrees of freedom of the test is increased.

The emulator is thus capable, for example, of providing filtered or unfiltered physical input quantities via its own buffer memories, as well as status and error information, so that any desired behavior of the original bus user may be represented on the data bus over a defined time period (depending on memory size and signals).

In addition, in an advantageous embodiment, one or all bus users may be scanned by the emulator and their behavior may be detected. This function is referred to as “eavesdropper.”

One advantage of the procedure according to the present invention is the use of a maximum number of original modules (for example, in the VHDL code). This allows the maximum degree of confidence in the tests and in the verification of the control units vis-à-vis the customer.

It may be advantageous if the emulator has the following components:

1. high-performance FPGA (Field-Programmable Gate Array); this is a freely programmable logic circuit and thus the heart of the emulator;
2. optionally, EEPROM/flash memory; this is an electronically erasable programmable memory module in which each byte may be deleted or written individually or data may be deleted or written by blocks only;
3. SD-RAM (Synchronous Dynamic Random Access Memory) as a special type of working memory; in principle, other types of working memories are also useable;
4. different bus transceivers for transmitting and receiving the signals via the data bus, coupling to the bus level and level conversion;
5. USB or Firewire co-controller, here as a special form of a human interface input, for example, from a control PC into the emulator;
6. AD converter for converting analog signals into digital signals, in particular when analog signals are to be fed into the emulator;
7. DA converter for converting digital signals into analog signals, in particular when the control unit receives analog signals from the emulator or test results are to be output in analog form;
8. timer, in particular when the emulator is to use a clock rate different from the system clock rate;
9. digital I/O (for example, trigger) for initializing the system and for stopping (pause) or aborting; this is also a type of human interface.

The input quantities for the particular bus users to be emulated may be directly transmitted in digital form into the SD-RAM with the aid of the USB/Firewire interface. Should the emulator also be used as a scanner (eavesdropper), the data may be transmitted, for example, from the SD-RAM to an external computer (PC) in the opposite direction. Furthermore, data may be continuously fed into the emulator with the aid of the AD converter. Analog or digital feed is thus possible using the accompanying converter. Simple monitoring or an analog stimulus is thus implemented in the emulator.

Due to the spatial separation of the emulated bus users and to the high data transmission rates, in general a transmission path having LVDS (=Low-Voltage Differential Signal)/LVDM (=Low-Voltage Differential Multipoint) drivers is established.

### BRIEF DESCRIPTION OF THE DRAWINGS

The present invention is explained in detail below with reference to the figures.

FIG. 1 schematically shows different processing levels for processing input quantities of an original bus user.

FIG. 2 schematically shows different processing levels for processing input quantities of an emulator replacing the original bus user.

FIG. 3 shows an example embodiment of a system according to the present invention for testing a control unit system.

### DETAILED DESCRIPTION OF EXAMPLE EMBODIMENTS

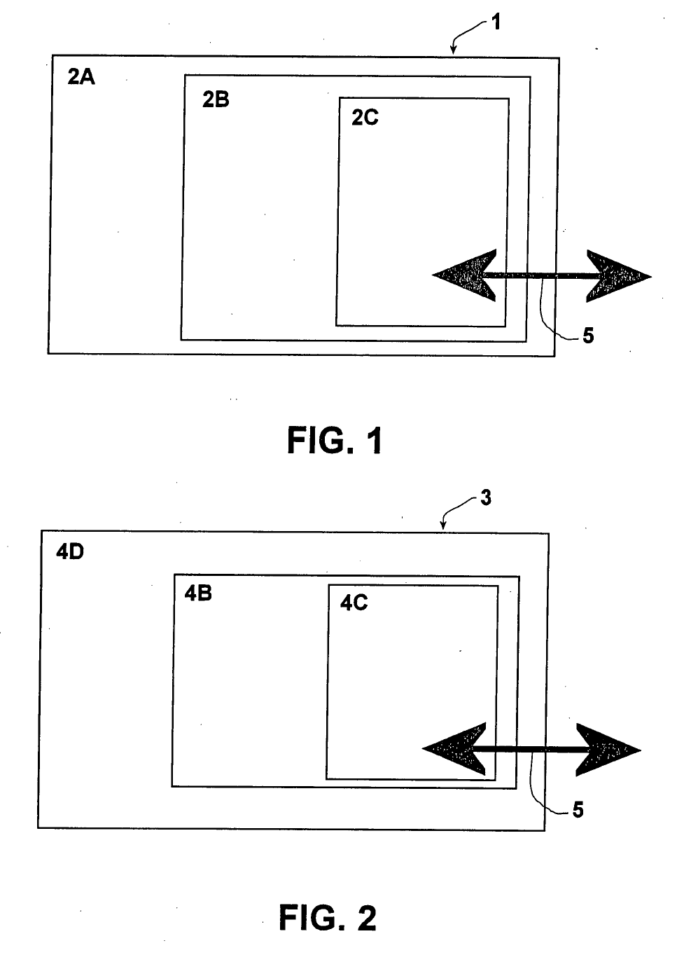

FIG. 1 schematically shows different processing levels or layers 2A, 2B, 2C of an original sensor 1, which represents a bus user in a control unit system, which has at least one control unit and at least one such sensor 1. Control unit and sensor, as well as additional bus users, are connected via a data bus through bus link 5. Such control unit systems are typically used in motor vehicles, in particular for implementing ESP, TCS, ABS vehicle systems described in the preamble.

Processing level 2A of sensor 1 contains the components required for coupling to the data bus, such as sensor head input, sensor signal processor, and an AD converter for converting the analog input signals into digital signal sequences. The two processing levels 2B and 2C are responsible for the following signal processing. Processing level 2B includes a filter module and units for setting a gain and an offset, as well as any additional components. Processing level 2C includes offset control, clipping, status register, error register, serial number (SN), state machine, among other things, and is therefore responsible for the internal signal conversion in particular.

The most often used form today is the implementation of such processing levels 2A, 2B, 2C in the form of a modular VHDL code.

According to an example embodiment of the present invention, one or more bus users are replaced by appropriate emulators for testing a control unit system. In this exemplary embodiment, sensor 1 is to be replaced by a sensor emulator 3. As mentioned previously, for this purpose most of the relevant units, namely in particular the protocol generator, output quantity processor, and logic/controller, may be transferred from the original bus user to the emulator hardware based on porting the corresponding VHDL modules. For the emulation of the physical bus coupling and input quantity processing as further relevant units, reference is made to FIG. 2.

FIG. 2 shows, as in FIG. 1, the corresponding processing levels in sensor emulator 3. Processing levels 4B and 4C correspond to processing levels 2B and 2C of original sensor 1. Most of the input quantity processing may thus be transferred. The emulator hardware contains the individually useable processing level labeled 4D, which processes the input quantities, as well as status and error information for the original modules in the same way as the original input quantity processing module.

Processing level 4D, which replaces processing level 2A of sensor 1, includes, for example, the following components: three channels for analog and digital 16-bit signal inputs (corresponding to the three axes of the vehicle), a RAM as memory, an analog-digital converter (ADC) and a digital-analog converter (DAC) for each of the above-mentioned channels, a USB (Universal Serial Bus) port for receiving data, for example, of a control PC, a high-performance FPGA such as, for example, an EPF10K50 or greater, an LVDS driver for, for example, an SPI or PAS bus, and optionally a freely useable UART (Universal Asynchronous Receiver/Transmitter) for extensions (CAN, etc.).

Further suitable components of sensor emulator 3 may be selected from the other components 1 through 9 listed above.

Sensor emulator 3 is thus capable of providing filtered or unfiltered physical input quantities via its own buffer memory, as well as status and error information, so that any desired behavior of the original bus user may be represented on the bus over a defined time period as in sensor 1. In addition, as mentioned previously, one or all bus users may be scanned by emulator 3 and their behavior may be detected.

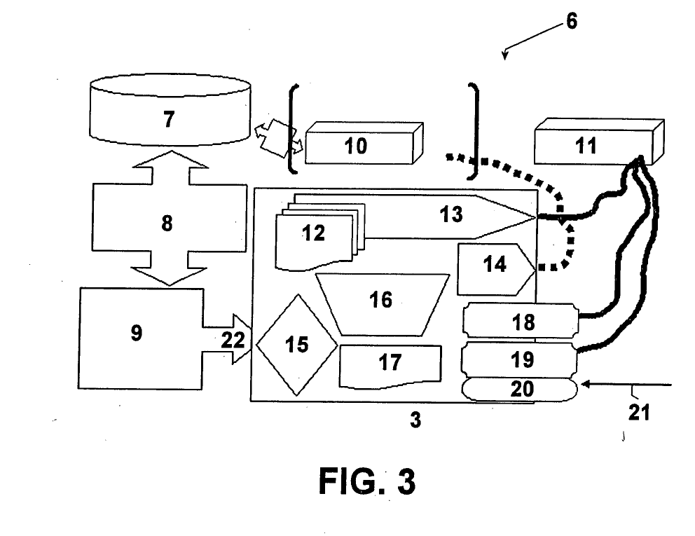

FIG. 3 schematically shows a concrete exemplary embodiment of a system 6 for testing a control unit system. This may be, for example, the case of the digital crash feed in airbag development.

The control unit (ECU) is labeled 11. The characteristics of control unit 11, which is a component of a vehicle system, for example, may be tested using the design according to FIG. 3. For this purpose, test data, for example, sensor data, are supplied to control unit 11. These test data are processed in control unit 11 and appropriate signals are output by control unit 11, for example, to actuators (not shown).

In the exemplary design shown here of a test system 6, there is a database 7, a preprocessing module 8, and a control PC 9. Control PC 9 communicates with USB 15 of emulator 3 via a USB interface 22. Emulator 3 is a bus user of the control unit system to be tested, in particular a sensor emulator. Furthermore, a curve generator 10 may be provided.

The components of emulator 3 are explained in detail above. Therefore, in the following, listing of the components should be sufficient: In addition to the USB (Universal Serial Bus) 15, there is a RAM 12 having, for example, 3×2 MB. Three channels, corresponding to the three vehicle axes, as well as three digital-analog converters (DAC) 13 and three analog-digital converters (ADC) 14 are provided. The FPGA is labeled 16. A latch 17 stores internal information such as status, ID, error, number, etc. An LVDS driver 18 is used for connection to an SPI bus; transmitter and receiver or transceiver 19 are provided for a PAS bus. The trigger input is labeled 20; trigger signal 21 is fed into trigger input 20.

A suitable test routine is called from database 7 for testing control unit 11. The test routine is supplied to a control PC 9, which is responsible for data transmission and control information, via a preprocessing module 8 for filter models and signal preprocessing. The test signals generated by control PC 9 are finally supplied to the appropriate bus (USB) 15 in emulator 3 via a USB interface 22.

Sensor emulator 3 performs exactly the same signal processing and output as the original sensor and relays a corresponding signal in analog or digital form to control unit 11.

The design depicted in FIG. 3 also makes it possible to generate analog signals as test signals using a curve generator 10, which are then fed into analog-digital converter 14 of emulator 3. The emulator depicted is thus designed for supplying analog and/or digital test signals. The actual test start is triggered by a trigger signal 21, which is applied to trigger input 20 of emulator 3.

1-16. (canceled)

17. A system for testing a control unit system, the control unit system having at least one control unit and at least one sensor, the control unit and the sensor being connected to one another via a data bus, the system for testing comprising:
an arrangement adapted to feed a test signal into a bus user for testing the control unit system; and
at least one emulator of the bus user.

18. The system as recited in claim 17, wherein other bus users are connected to the bus.

19. The system as recited in claim 17, wherein the bus user into which the test signal is fed is the emulator.

20. The system as recited in claim 19, wherein the emulator emulates the sensor.

21. The system as recited in claim 17, wherein the emulator has a scanner function to detect data from other bus users.

22. The system as recited in claim 17, further comprising:
a computer for data transmission and control information, the computer having an interface to the emulator.

23. The system as recited in claim 17, wherein the emulator is adapted to process at least one of digital and analog output quantities.

24. The system as recited in claim 17, wherein the emulator is adapted to output at least one of digital and analog output quantities.

25. The system as recited in claim 17, wherein the emulator has different processing levels including levels responsible for at least one of signal processing and filtering which correspond to the emulated bus user.

26. The system as recited in claim 17, wherein the emulator includes an individually useable processing level which replaces a processing level responsible for coupling the emulated bus user to the control unit.

27. A method for testing a control unit system having at least one control unit and at least one sensor, the control unit and the sensor being connected to one another via a data bus, the method comprising:
emulating, by an emulator, a bus user; and
a feeding test signal being fed into a bus user of the data bus for testing the control unit system.

28. The method as recited in claim 27, wherein other bus users are connected to the data bus.

29. The method as recited in claim 27, wherein the bus user into which the test signal is fed is the emulator.

30. The method as recited in claim 29, wherein the emulator emulates the sensor of the control unit system.

31. The method as recited in claim 27, further comprising:
scanning, by the emulator, to detect data of other bus users.

32. The method as recited in claim 27, further comprising:
transmitting data and control information into the emulator via a computer.

33. The method as recited in claim 27, further comprising:
feeding at least one of digital and analog input quantities into the emulator.

34. The method as recited in claim 27, further comprising:
outputting at least one of digital and analog output quantities by the emulator.
